(19) United States
(12) Patent Application Publication
(10) Pub. No.: US 2025/0144796 A1
(43) Pub. Date: May 8, 2025

(54) METHOD FOR CONTROLLING A ROBOT APPARATUS

(71) Applicant: Robert Bosch GmbH, Stuttgart (DE)

(72) Inventors: Yuchen Liu, Sindelfingen (DE); Luigi Palmieri, Stuttgart (DE)

(21) Appl. No.: 18/932,014

(22) Filed: Oct. 30, 2024

(30) Foreign Application Priority Data
Nov. 3, 2023 (DE) 10 2023 210 950.6

(51) Int. Cl. B25J 9/16

(52) U.S. Cl. CPC B25J 9/1661; B25J 9/163; B25J 9/1664

(57) ABSTRACT

A method for controlling a robot apparatus. The method includes collecting state information about an agent located in an environment of the robot apparatus, converting the state information about the agent into a textual state description, feeding the textual state description to a large language model for generating a prediction of a behavior of the agent, a future state of the agent and/or the environment, generating a task plan for the robot apparatus taking into account the prediction, and controlling the robot apparatus according to the task plan.

### CROSS REFERENCE

The present application claims the benefit under 35 U.S.C. § 119 of German Patent Application No. DE 10 2023 210 950.6 filed on Nov. 3, 2023, which is expressly incorporated herein by reference in its entirety.

### FIELD

The present invention relates to a method for controlling a robot apparatus.

### BACKGROUND INFORMATION

In many applications, it is desirable for robots to be able to operate autonomously in environments in which humans are present or (other) obstacles are present. Here, in their control they must in particular be able to take into account the possible behavior of dynamic objects or “agents” in their environment, such as humans. For this reason, approaches are desirable that make possible a safe automatic control of robot apparatuses in environments in which agents such as humans are present, who/which move within and/or influence the state of the particular environment, such as for example move objects.

According to various embodiments of the present invention, a method for controlling a robot apparatus is provided, comprising collecting state information about an agent located in an environment of the robot apparatus, converting the state information about the agent into a textual state description, feeding the textual state description to a large language model for generating a prediction of a behavior of the agent, of a future state of the agent and/or of the environment, generating a task plan for the robot apparatus taking into account the prediction, and controlling the robot apparatus according to the task plan.

The method according to the present invention described above makes possible the safe and successful control of a robot apparatus in a dynamic environment, i.e., an environment in which one or more agents are acting or interacting with it, i.e., in which, for example, humans are present. In particular, this makes collaboration possible between one or more humans and a robot. According to various embodiments, the control (in particular predictions of the state of the environment and task planning) for the robot apparatus (e.g., in a cluttered and dynamic environment) is performed by means of one or more large language models (LLMs). It has become apparent that LLMs can react in the same way as a human (e.g., as a chatbot). For this reason, they are also suitable for predicting human behavior.

Various exemplary embodiments of the present invention are specified below.

Exemplary embodiment 1 is a method for controlling a robot apparatus, as described above.

Exemplary embodiment 2 is the method according to exemplary embodiment 1, comprising training the large language model for predicting agent behavior from textual state descriptions.

For example, the LLM can be trained using deep learning (e.g., by minimizing the difference between a target output from a training data set and an actual output from the model by means of an optimizer). It is thus adapted to its use for a control system. The LLM can also be pre-trained.

Exemplary embodiment 3 is the method according to exemplary embodiment 1 or 2, comprising generating the task plan by feeding a textual goal description, a textual environment description and a textual description of the state of the robot apparatus to the or to a further LLM (“LLM planner”).

This can be a further LLM or the same LLM can be further prompted correspondingly (so that it takes the prediction into account). A task plan can thus be generated efficiently.

Exemplary embodiment 4 is a method according to exemplary embodiment 1 or 2, comprising generating the task plan by feeding to a further LLM (“LLM planner”) the prediction (textual as output of the LLM) and a textual goal description, a textual environment description and a textual description of the state of the robot apparatus.

The separation into two LLMs makes possible the fine-tuning or training of both LLMs for the particular task (e.g., through reinforcement learning, e.g., reinforcement learning from human feedback).

Exemplary embodiment 5 is the method according to exemplary embodiment 4, comprising training the further large language model for generating task plans.

The further LLM can be trained using reinforcement learning (e.g., by means of rewards received for controlling the robot apparatus using the task plans generated for it). It is thus adapted to its use for a control system.

Exemplary embodiment 6 is the method according to one of exemplary embodiments 1 to 5, comprising generating a scene graph from the state information collected and from further information about the environment of the robot apparatus and generating the textual state description from the scene graph.

This makes possible the efficient generation of the textual state description, since, for example, relationships between agents and other objects (or rooms, etc.) that the scene graph represents (by edges) can be converted directly into text.

Exemplary embodiment 7 is a (e.g., robot) control device configured to carry out a method according to one of exemplary embodiments 1 to 6.

Exemplary embodiment 8 is a computer program comprising commands which, when executed by a processor, cause the processor to carry out a method according to one of exemplary embodiments 1 to 6.

Exemplary embodiment 9 is a computer-readable medium storing commands which, when executed by a processor, cause the processor to carry out a method according to one of exemplary embodiments 1 to 6.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWING

FIG. 1 shows a control scenario, according to an example embodiment of the present invention.

FIG. 2 illustrates a data flow for the control of a robot apparatus according to one example embodiment of the present invention in a particular control device.

FIG. 3 shows an example of a scene graph for a control scenario, in which a mobile robot is to be navigated over a floor of a building.

FIG. 4 illustrates the functionality of a prediction and task-planning module according to one example embodiment of the present invention.

FIG. 5 shows a flowchart that represents a method for controlling a robot apparatus according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed.

Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

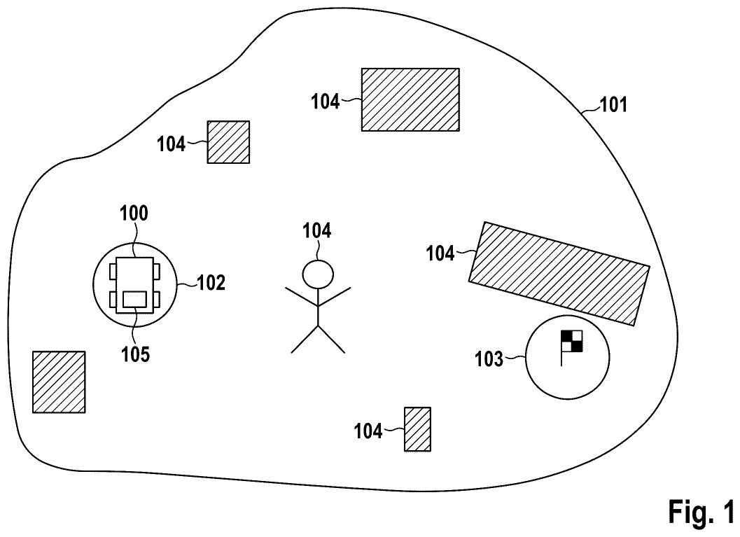

FIG. 1 shows a control scenario.

A mobile robot 100 is located in an environment 101 (e.g., in a factory hall or on the grounds of a construction site). The robot 100 has a starting position 102 and is to reach a destination position 103. There are obstacles 104 in the environment 101 that the robot 100 is to circumvent. They must, e.g., not be passed by the robot 100 (e.g., machines, walls or trees) or should be avoided because the robot would damage or injure them (e.g., humans, e.g., in a factory hall in which the robot 100 is being used to transport objects).

The robot 100 has a control device 105 (which can also be spatially separated from the robot 100, i.e., the robot 100 can be controlled remotely). In the example scenario of FIG. 1, the goal is that the control device 105 controls the robot 100 in order to navigate through the environment 101 from the starting position 102 to the destination position 103. The robot 100 is, for example, an autonomous vehicle but can also be a robot with legs or tracks or another type of propulsion system (e.g., a deep-sea or Mars rover).

Furthermore, the embodiments are not limited to the scenario in which a robot (as a whole) is to be moved between the positions 102, 103 but can also be used for controlling a robot arm whose end effector is to be moved between the positions 102, 103 (without encountering obstacles 104), etc.

Accordingly, terms such as robot, vehicle, machine, etc. are used below as examples of the “object” or agent to be controlled, i.e., the computer-controlled technical system (e.g., the machine). The approaches described here can be applied to various types of computer-controlled machines such as robots or vehicles and others (and possibly their environment). The general term “robot apparatus” is also used below for all types of technical systems (which are mobile and/or have one or more movable components) that can be controlled using the approaches described below.

Ideally, the control device 105 has learned a control strategy that makes it possible for it to successfully control the robot 100 for any scenarios (i.e., environments, starting and destination positions) in certain scenarios that the control device 105 has not yet encountered (from the starting position 102 to the destination position 103, without encountering obstacles 104).

The control unit 105 is suitably trained for this purpose. For such training, the scenario (in particular the environment 101) can also be simulated, but in the field it is usually real. However, the robot 100 and the environment can still be simulated in the field (e.g., if a simulation of vehicles (according to the control strategy) is used for testing a (different) control strategy of an autonomous vehicle).

According to various embodiments, a control device for a robot apparatus (e.g., the control device 105) is provided which uses a large language model (LLM) in order to predict the behavior of an agent (or a result of the behavior) in the environment of the robot apparatus. These predictions can then be created by a task planning module of the control device for task planning. For example, human behavior in an indoor environment is predicted, e.g., where a human moves to in order to avoid a collision between a human and a robot.

In recent years, with the enormous advances in natural language processing (NLP) and generative artificial intelligence (AI) research, various powerful LLMs have been developed which are capable of producing human-like text.

According to various embodiments, one or more LLMs are used to predict future activities or behaviors of an agent (e.g., a human). As a result, the robot 100, for example, can navigate through a cluttered environment with (possibly many) humans, i.e., human “obstacles” 104, since it has been shown that LLMs are able to learn “common sense” and are therefore also suitable for predicting the behavior of humans. In the following one or more humans are taken as an example, but the behavior of other “agents,” such as animals (e.g., for the navigation of a robot in a cowshed), could also be predicted in a similar way.

According to various embodiments, for example, a prediction and planning module is provided for a control device for a mobile robot in an overcrowded indoor environment, which receives the following inputs (information):
A description of the type of environment
A description of the task
Sensor data on the current position of the robot
A scene graph with all objects in the environment and their relationships, e.g., including one or more agents (e.g., humans).

The prediction and task-planning module uses one or more LLMs in order to predict human behavior and create a (high-level) task plan in order to achieve the user-defined goal (i.e., the task) while minimizing certain costs (e.g., travel distance, cost of human-robot interaction, etc.).

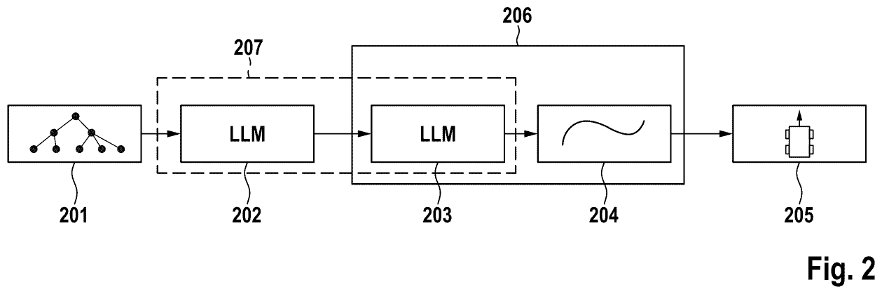

FIG. 2 illustrates a data flow for the control of a robot apparatus (e.g., an autonomous system such as a self-driving robot) according to one embodiment in a particular control device.

Perception (or sensing) 201 provides information about the environment of the robot apparatus (according to various embodiments in the form of a scene graph). From this information, a prediction 202 about a future state of the environment is made. This prediction 202 is used for task planning 203. Once the carrying out of the task has been planned (e.g., first move to point A, wait for 5 seconds, then move to point B), motion planning 204 is carried out (i.e., the trajectory(s) for executing the particular motion(s) according to the task plan is/are ascertained). Control 205 of the robot apparatus is then carried out according to the motion planning.

The functionality of task planning 203 and motion planning 204 can be combined to form the functionality of “planning,” which can be the functionality of a planning module 206. Task planning 203 (which can be seen as “high-level” planning) can thus be seen (at least primarily) as part of the planning level of the particular autonomous system. In the present description, the functionality of prediction 202 and of task planning 203 are combined to form the functionality of a “prediction and task-planning module” 207.

According to various embodiments, sensing 201 provides information in the form of a scene graph that contains all objects (including static and dynamic objects, i.e., robots and humans) in the environment as nodes and the relationships between the objects as edges.

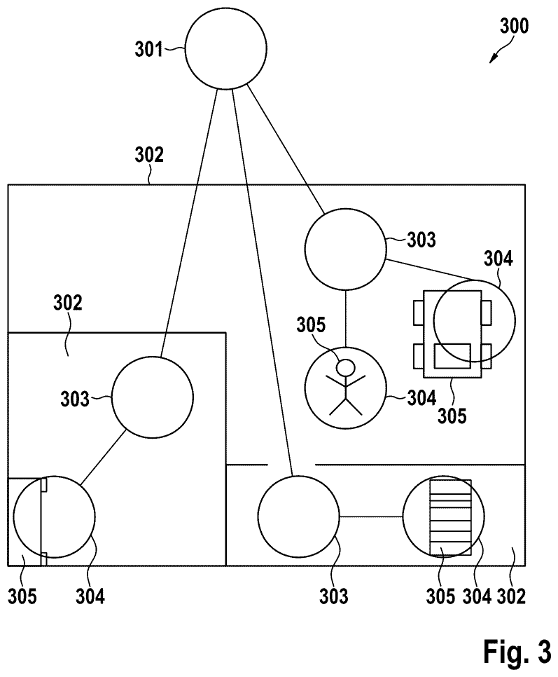

FIG. 3 shows an example of a scene graph 300 for a control scenario in which a mobile robot is to be navigated over a floor of a building.

In this example, the scene graph 300 has the shape of a tree. The root 301 of the scene graph is assigned to the floor here. For each room 302 of the floor, the scene graph 300 contains an inner (i.e., neither root nor leaf) node 303 of the scene graph 300 assigned to the particular room. Each leaf (i.e., each leaf node) 304 of the scene graph 300 is associated with a particular object 305 (or also a particular location in the room) and is connected to the node 300 assigned to the room in which the particular object 305 is located.

Each node (root, inner node and leaves) can have one or more properties (also known as attributes). These can be binary properties, e.g., for an internal node “Object_in_Room=true,” “Robot_in_Room=true,” or for a leaf node “to_be_opened=false,” “is_pickable=true,” and also other non-binary attributes such as for a leaf node “Category=Bed,” “Weight=10 kg,” or for an internal node “Room_Type=Storeroom,” the position and/or speed of the object, etc., or for the root “Floor_Type=Basement.” One or more of the objects are, for example, agents, i.e., humans in this example (they are characterized, for example, by the binary property “is Human=true” or more generally “is_Dynamic_Object=true”). The robot itself can also be represented by a leaf. Nodes that are assigned to objects (object nodes) can be human nodes, robot nodes or environment nodes, depending on what they represent (humans, robots or other objects in the environment).

The scene graph 300 can also have further levels, for example, rooms can first be divided into locations (which in each case are assigned to a node that is connected to the particular room node) and objects can then be specified for these. There can also be relations between objects (e.g., a box is on a shelf). An edge can then be created in order to connect these two object nodes and describe the relationship. If an agent is in the vicinity (at a Euclidean distance) of an object or is directly related to it (e.g., a human is sitting on a chair), the two corresponding nodes can also be connected by an edge (however, there are no edges between two agent nodes, for example). The scene graph may then no longer have the shape of a tree.

According to various embodiments, the prediction 202 uses an LLM to predict human behavior. The predictions are provided as input for task planning 303, which then outputs a task plan using a different LLM for motion planning 204 in order to calculate a motion trajectory for the robot. The control system 205 calls up the corresponding actuators (e.g., for moving arms, wheels, etc.) in order to follow the motion trajectory.

For example, this is used in a factory scenario for the assembly of an e-bike, in which the robot has to collect 100 different parts of the e-bike, e.g., steering wheel, rear wheel, frame, battery and seat, from different locations and bring them one after the other to the assembly area without passing through areas occupied by humans (i.e., without colliding with or obstructing humans).

A task-planning problem is given by a tuple (O, P, A, T, C, I, G). O is the set of all basic objects of the problem. P is a set of properties (or attributes), which in each case are defined by one or more objects (binary properties are subclasses of attributes that have Boolean values). A is a finite set of actions that operate on object tuples. T is a state transition model and C denotes the costs of state transitions. I is an initial state and G denotes one or more goal states. A state is an12ssignent of values to all possible properties of the objects. As described above, it is described, for example, by a scene graph (at least partially, e.g., information about the robot state (such as joint positions etc.) can also be available as additional information).

A language model (LM) can be seen as a distribution over sequences of word tokens. One approach is to model the conditional distribution p(wₖ|w_{1:k}) over wₖ, the next token at the k-th position, given a sequence of previous input tokens w_{1:k}. More recent LMs are based on the transformer architecture, which significantly scales up LMs, leading to large language models (LLMs), which typically have dozens or hundreds of billions of parameters and are capable of generating human-like text or programming code.

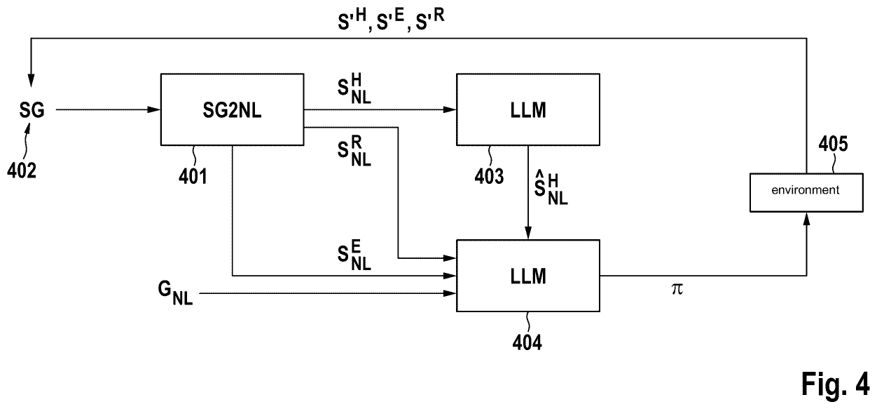

FIG. 4 illustrates the functionality of a prediction and task planning module 400 according to one embodiment.

The prediction and task-planning module 400 contains an “SG2NL” module 401 that converts a scene graph (SG) 402 into a natural language description of the scene that the scene graph describes (i.e., the state) (e.g., a description in words of the properties or states of the objects assigned to the leaves), an LLM predictor “LLM_{Pred}” 403 that predicts human behavior, and an LLM planner “LLM_{Plan}” 404 that creates a task plan for the robot.

The inputs of the prediction and task-planning module 400 are the scene graph 402 and a user-defined goal description in natural language G_{NL}, and its output is a generated task plan π. As explained above, the scene graph 402 consists of a plurality of nodes and edges, as shown in FIG. 3: some of the nodes (e.g., the leaves) represent the objects and the agents (e.g., a human and also the robot itself) in the environment, nodes (including the leaves) can have a plurality of attributes, e.g., position, orientation, actions of the human or of the robot, etc.

Algorithm 1 gives an example of creating a task plan from the scene graph for a goal G_{NL} in pseudocode (using the usual English keywords such as while, do and end).

Algorithm 1: Task planning with prediction of human behavior

| | | Input: SG, G_{NL} |
|---|---|---|
| | | Output: π |
| 1 | while G_{NL} not reached do | |
| 2 | \| | Ascertain S^{H}, S^{E} and S^{R} out SG |
| 3 | \| | S_{NL}^{H}, S_{NL}^{E}, S_{NL}^{R} ← SG2NL(SG) |
| 4 | \| | Ŝ_{NL}^{H} ← LLM Pred (S_{NL}^{H}) |
| 5 | \| | π ← LLM Plan (G_{NL}, S_{NL}^{R}, S_{NL}^{E}, Ŝ_{NL}^{H}) |
| 6 | \| | S′^{H}, S′^{E}, S′^{R} ← Execute(π) |
| 7 | \| | Update SG with S′^{R}, S′^{H} and S′^{E} |
| 8 | \| | S^{H} ← S′^{H}, S^{E} ← S′^{E}, S^{R} ← S′^{R} |

| | |
|---|---|
| 9 | end |

In line 2 of algorithm 1, the human states S^{H} (of one or more humans), the environment states S^{E} and the robot state S^{R} are ascertained from the scene graph SG, where S^{H} and S are two sets of attributes of human nodes and environment nodes (for other objects and also rooms), and S^{R} is the set of attributes of the robot node.

In line 3, the scene graph 402 is parsed by the SG2NL module 401. The SG2NL module 401 converts the scene graph 402 into an NL description of the human states S^{H}_{NL}, of the environment states S^{E}_{NL} of the robot state S^{R}_{NL}, where S^{H}_{NL}, S^{E}_{NL} and S^{R}_{NL} are textual sentences in natural language.

Then S^{H}_{NL} is passed to the LLM predictor 403, which generates a prediction of future human behavior in natural language Ŝ^{H}_{NL} (line 4), which attaches the predicted human behavior to the current human state. An example of an output prediction could be: “The human is standing in front of a refrigerator, he will soon open the refrigerator.”

The description of the environment states S^{E}_{NL} is passed together with the goal description G_{NL}, the robot state in natural language S^{R}_{NL} and the prediction of the human state in natural language Ŝ^{H}_{NL} to the LLM planner 404, which generates a task plan π (e.g., a sequence of steps) that guides the robot to the given task goal (line 5).

For example, a task plan for putting an apple into a refrigerator could look like this: “Go to the refrigerator, wait until the human leaves the area of the refrigerator, open the refrigerator, put the apple into the refrigerator, close the refrigerator.”

The LLM predictor 404 and the LLM planner 403 can be the same pre-trained LLM, but may be given different prompts.

The task plan π is then executed by the robot and it interacts with the environment 405, and the next human states S′^{H}, environment states S′^{E} and the next robot state S′^{R} are observed (line 6). The scene graph is then updated accordingly by the state changes (line 7). This process is repeated until the user-defined goal is reached.

Algorithm 2 gives an example of the conversion of the scene graph SG into natural language by the SG2NL module (the usual English keywords such as for, do, end, if, else, then are also used here).

Algorithm 2: Conversion of a scene graph into natural language

| | Data: SG | | |
|---|---|---|---|
| | Result: S_{NL}^{H}, S_{NL}^{E}, S_{NL}^{R} | | |
| 1 | S_{NL}^{H} ← Ø, S_{NL}^{E} ← Ø, S_{NL}^{R} ← Ø | | |
| 2 | for n ∈ SG do | | |
| 3 | \| | Ascertain all edges and neighboring nodes of n | |
| 4 | \| | Ascertain relationships from edges and object types of neighbors | |
| 5 | \| | if n human node then | |
| 6 | \| | \| | Add all relations and neighbors to S_{NL}^{H} |
| 7 | \| | end | |
| 8 | \| | else if n environment nodes then | |
| 9 | \| | \| | Add all relations and neighbors to S_{NL}^{E} |
| 10 | \| | end | |
| 11 | \| | else | |
| | \| | \| | // n is robot node |
| 12 | \| | \| | Add all relations and neighbors to S_{NL}^{R} |

| | | |
|---|---|---|
| 13 | \| | end |

| | |
|---|---|
| 14 | end |

First, the NL descriptions of the human states S^{H}_{NL}, the environment states S^{E}_{NL} and the robot state S^{R}_{NL} are initialized as empty (line 1). From line 2 to 10, all nodes in the scene graph are run through in a loop. For each node, all edges (i.e., relationships) and neighboring nodes (i.e., neighboring objects and humans) are accessed (line 3-4). If a node is a human node, the current state of the human (position, orientation and action) and his relationships to all neighboring objects and humans are converted into text and added to S^{H}_{NL} (line 5-7). If the node is an environment node that represents another object, the position of the object and its relationships to all neighboring objects (including humans) are recorded in S^{E}_{NL}(lines 8-10). Otherwise, the relationships to all neighboring objects and humans of the robot node are added to S^{R}_{NL} (line 12).

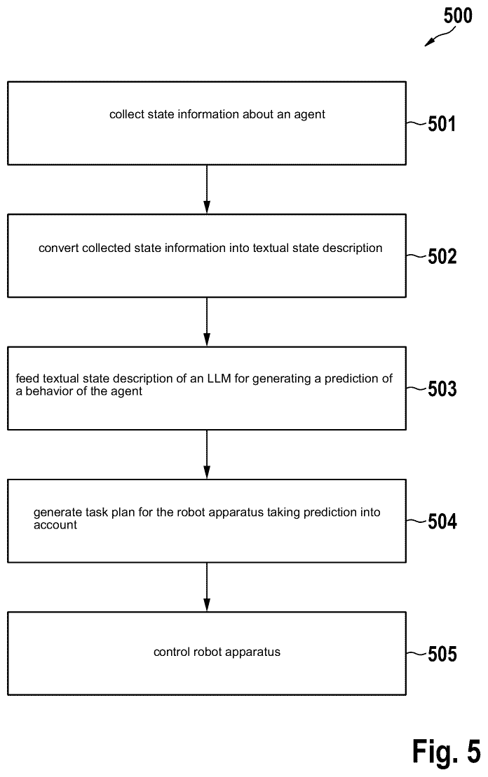

In summary, according to various embodiments a method is provided as shown in FIG. 5.

FIG. 5 shows a flowchart 500 that represents a method for controlling a robot apparatus according to an embodiment.

In 501, state information is collected about an agent (e.g., human or animal, i.e., a “dynamic object” that moves in the environment and may influence the environment, e.g., a human can remove another object from the environment or carry it somewhere else) located in an environment of the robot apparatus.

In 502, the state information about the agent is converted into a textual state description.

In 503, the textual state description is fed to an LLM (“LLM predictor”) for generating a prediction of a behavior of the agent, a future state of the agent and/or of the environment (for example, the LLM can output the behavior of the agent or the result of the behavior with respect to the state of the environment (including the agent itself)). In other words, the textual state description is fed to a (trained) LLM in order to generate the prediction.

In 504, a task plan for the robot apparatus is generated taking the prediction into account.

In 505, the robot apparatus is controlled according to the task plan.

The method of FIG. 5 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the particular functions described in more detail herein may also be understood as a data processing unit or logic circuit assembly. One or more of the method steps described in detail here can be executed (e.g., implemented) by a data processing unit by means of one or more special functions that are performed by the data processing unit.

The method is therefore in particular computer-implemented according to various embodiments.

Controlling the robot apparatus according to the task plan involves generating one or more control signals for the robot apparatus. The term “robot apparatus” may be understood to refer to any technical system (comprising a mechanical part whose motion is controlled), such as a computer-controlled machine, a vehicle, a household appliance, a power tool, a manufacturing machine, a personal assistant or an access control system.

Various embodiments may receive and use sensor signals from various sensors such as video, radar, lidar, ultrasound, motion, thermal imaging, etc., for example in order to provide sensor data for state information. The sensor data can be processed in order to obtain state information (i.e., for sensing). This can comprise the classification of the sensor data or the performance of a semantic segmentation of the sensor data, for example in order to detect the presence of objects (in the environment in which the sensor data were obtained).

What is claimed is:

1. A method for controlling a robot apparatus, comprising the following steps:
collecting state information about an agent located in an environment of the robot apparatus;
converting the state information about the agent into a textual state description;
feeding the textual state description to a large language model for generating a prediction of a behavior of the agen and/or of a future state of the agent and/or of the environment;
generating a task plan for the robot apparatus taking into account the prediction; and
controlling the robot apparatus according to the task plan.

2. The method according to claim 1, further training the large language model for predicting agent behavior from textual state descriptions.

3. The method according to claim 1, further comprising generating the task plan by feeding a textual goal description, a textual environment description and a textual description of a state of the robot apparatus to the large language model or a further large language model.

4. The method according to claim 1, further comprising generating the task plan by feeding the prediction and a textual goal description, a textual environment description, and a textual description of the state of the robot apparatus, to a further large language model.

5. The method according to claim 4, further comprising training the further large language model for generating task plans.

6. The method according to claim 1, further comprising generating a scene graph from the collected state information and from further information about the environment of the robot apparatus and generating the textual state description from the scene graph.

7. A control device configured to control a robot apparatus, the control device configured to:
collect state information about an agent located in an environment of the robot apparatus;
convert the state information about the agent into a textual state description;
feed the textual state description to a large language model for generating a prediction of a behavior of the agen and/or of a future state of the agent and/or of the environment;
generate a task plan for the robot apparatus taking into account the prediction; and
control the robot apparatus according to the task plan.

8. A non-transitory computer-readable medium on which are stored commands for controlling a robot apparatus, the commands, when executed by a processor, causing the processor to perform the following steps:
collecting state information about an agent located in an environment of the robot apparatus;
converting the state information about the agent into a textual state description;
feeding the textual state description to a large language model for generating a prediction of a behavior of the agen and/or of a future state of the agent and/or of the environment;
generating a task plan for the robot apparatus taking into account the prediction; and
controlling the robot apparatus according to the task plan.
